(19) United States
(12) Patent Application Publication
(10) Pub. No.: US 2009/0196486 A1
(43) Pub. Date: Aug. 6, 2009

(54) Automatic Method and System for Visual Inspection of Railway Infrastructure

(75) Inventors: Arcangelo Distante, Bari Ba (IT); Francescomaria Marino, Bari Ba (IT); Pier Luigi Mazzeo, Bari Ba (IT); Massimiliano Nitti, Bari Ba (IT); Ettore Stella, Bari Ba (IT)

Correspondence Address: NIXON & VANDERHYE, PC, 901 NORTH GLEBE ROAD, 11TH FLOOR, ARLINGTON, VA, 22203, US

(73) Assignee: CONSIGLIO NAZIONALE DELLE RICERCHE, Roma RM (IT)

(21) Appl. No.: 11/988,449

(22) PCT Filed: Jul. 17, 2006
(86) PCT No.: PCT/IB2006/052438

§ 371 Date: Dec. 31, 2008

(30) Foreign Application Priority Data
Jul. 18, 2005 (IT) RM2005A000381

(51) Int. Cl. G06K 9/00

(52) U.S. Cl. 382/141

(57) ABSTRACT

The present invention relates to a visual inspection system and method for the maintenance of infrastructures, in particular railway infrastructures. It is a system able to operate in real time, wholly automatically, for the automatic detection of the presence/absence of characterizing members of the infrastructure itself, for example the coupling locks fastening the rails to the sleepers.

The present invention relates to a visual inspection system for the maintenance of railway infrastructures. In particular, the present invention relates to a system for automatically detecting the presence/absence of the coupling locks fastening the rails to the sleepers.

The maintenance of the railway infrastructures is included in a particular applicative context therefor a periodical inspection is necessary to prevent dangerous situations. Usually, this operation is visually performed by specialized personnel which, periodically, runs along the railway network looking for the anomalies at sight.

Evidently, such manual inspection is slow, laborious and potentially risky as the provided results are strictly linked to the observer's ability in detecting possible anomalies and in recognizing critical situations.

With the growth of the high speed railway traffic, the companies of all over the world are interested in developing automatic inspection systems able to recognize the track's defects, the sleepers' anomalies, as well as the absence of coupling locks.

Such systems can increase the ability in recognizing the defects and in reducing the inspection time so as to guarantee more frequent maintenance works of the railway network.

As it is known, a rail can be fastened to the sleepers by using two kinds of coupling locks: hexagonal-head bolts or hook bolts.

These two kinds of locks mainly differ in the shape: the first one has a regular hexagonal shape with a random orientation, the second one has a more complex hook-like shape which can be oriented in one single direction.

The present invention will be described by referring to the case of octagonal-head bolts, even if, as it will be evident hereinafter, the same invention could find direct application in the other case as well as in the need for detecting other types of defects.

Devices are well known in literature relating to the problems connected to the railway infrastructures, like for example a system for measuring the profile of the rotating track such as the one described in C. Alippi, E. Casagrande, F. Scotti, and V. Piuri, “Composite Real-Time Image Processing for Railways Track Profile Measurement,” IEEE Trans. Instrumentation and Measurement, vol. 49, Nr. 3, pages 559-564, June 2000, or a system for detecting obstructions as described in K Sato, H. Arai, T. Shimuzu, and M. Takada, “Obstruction Detector Using Ultrasonic Sensors for Upgrading the Safety of a Level Crossing,” Proceedings of the IEE International Conference on Developments in Mass Transit Systems, pages 190-195, April 1998, a system recognizing the track's defects as described in Cybernetix Group (France), “IVOIRE: a system for rail inspection,” internal documentation, http://www.cybernetix.fr and/or in Benntec Systemtechnik Gmbh, “RAILCHECK: image processing for rail analysis,” internal documentation, http://www.benntec.com, a system for inspecting the status of the switches as described in A. Rubaai, “A neural-net-based device for monitoring Amtrak railroad track system,” IEEE Transactions on Industry Applications, vol. 39, Nr. 2, pages 374-381, March-April 2003, etc.

Nevertheless, currently there are no systems working onto specific problems for recognizing the coupling members.

The only existing methods are visual trade systems which take into consideration exclusively coupling members having regular geometrical profiles (such as the hexagonal bolts) and they use geometrical methods for recognizing images for analyzing the problem.

Nevertheless, such systems are very interactive and, in order to obtain the best performance, they need a human operator for calibrating each threshold. Therefore, when a different coupling member has to be examined, the calibrating phase must be performed again.

Therefore, the object of the present invention is to solve the problems mentioned above, by providing an automatic method for visually inspecting an infrastructure, for detecting members characterizing the infrastructure itself as defined in the independent claim Nr. 1.

An additional object of the present invention is to provide a corresponding automatic automatized system for visually inspectioning an infrastructure, for detecting the members characterizing the infrastructure itself as defined in claim Nr. 15.

Secondary features of the present invention are defined in the respective depending claims.

The present invention, by overcoming the cited problems of the known art, involves numerous and evident advantages.

The inspection system according to the present invention is wholly automatic, it can operate in off-line mode, as well as in the preferred real time mode and it does not require a calibrating phase depending upon the type of member to be controlled. The human operator intervenes only in the process of selecting the images of the locking members to be controlled.

Furthermore, the inspection method according to the present invention does not put any limit to the shape of the members to be controlled, being able to be adapted both to geometrical and irregular profiles.

Additional advantages, as well as features and application modes of the present invention will be evident from the following detailed description of a preferred embodiment thereof, shown by way of example and not for limitative purposes, by referring to the figures of the enclosed drawings, wherein:

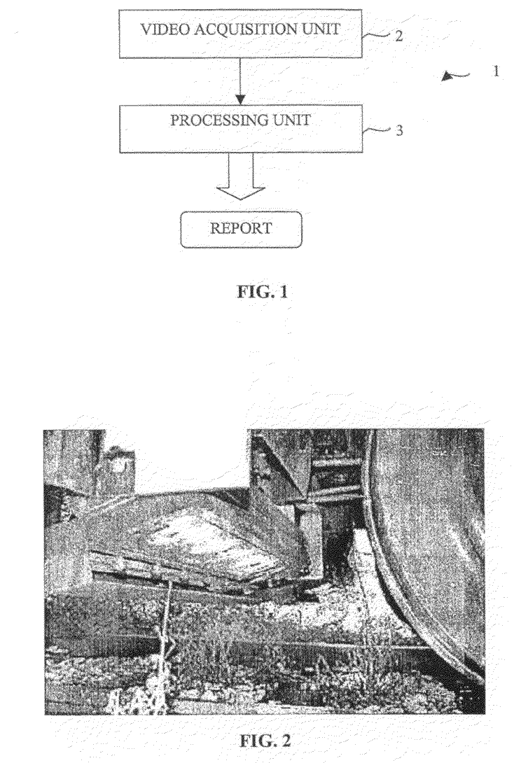

FIG. 1 is a block diagram indicating the system according to the present invention;

FIG. 2 is a view of the video acquisition system;

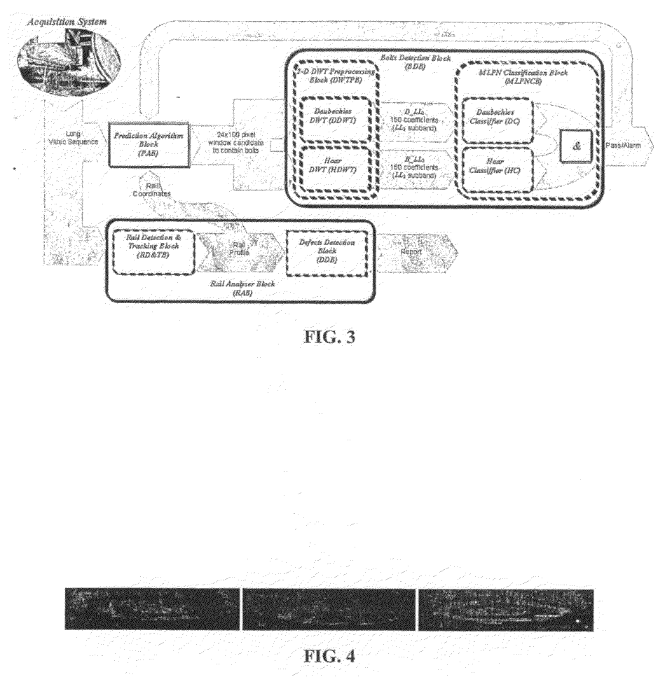

FIG. 3 is a more detailed block diagram of the system according to the present invention;

FIG. 4 shows three images of sub-image windows extracted from the acquired images;

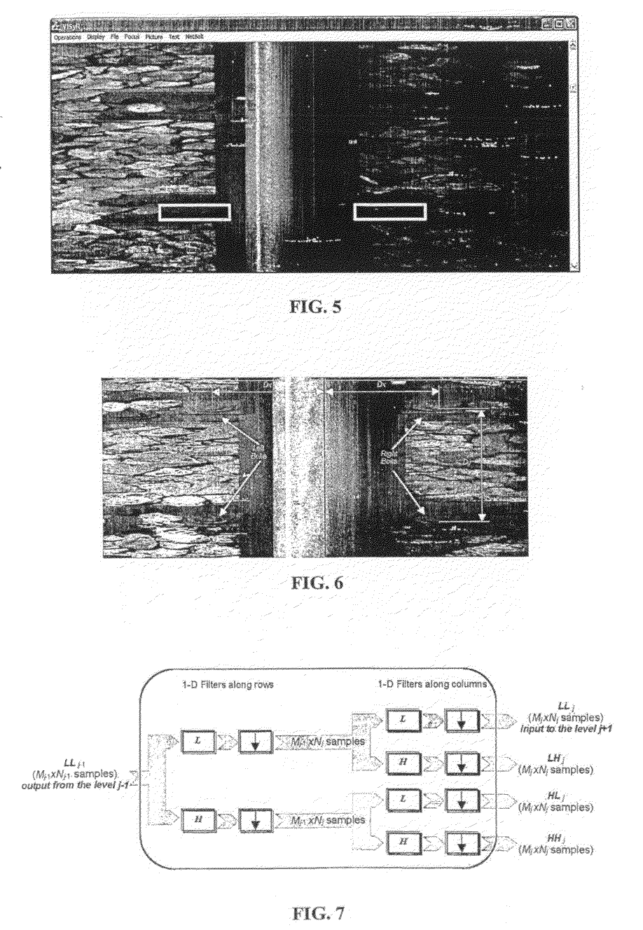

FIG. 5 is a visual display of the software programme implementing the method according to the present invention;

FIG. 6 illustrates the geometry of a rail;

FIG. 7 shows schematically a general decomposition level of a bi-dimensional wavelet transformation;

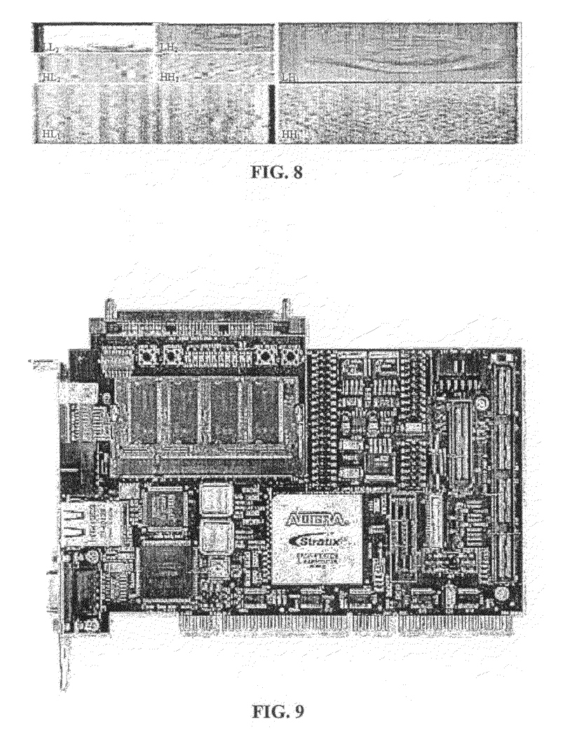

FIG. 8 shows the result of applying two 2-D DWT levels to a sub-image;

FIG. 9 shows a card used as prototype development platform;

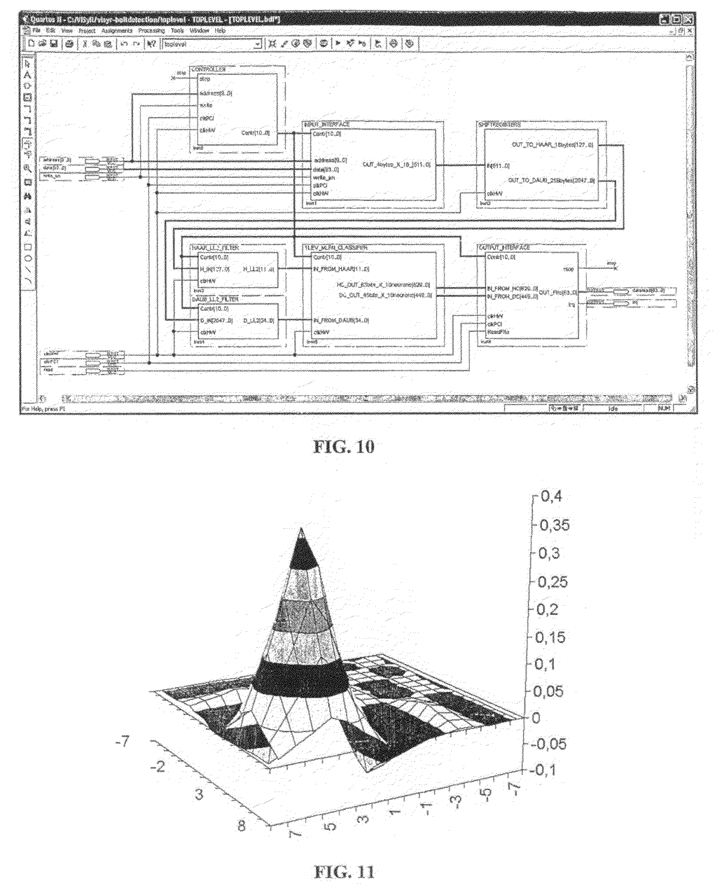

FIG. 10 shows a visual display extracted from the development system of the card of FIG. 9;

FIG. 11 shows a representation of a kernel used in the calculation of the 2-D transforms;

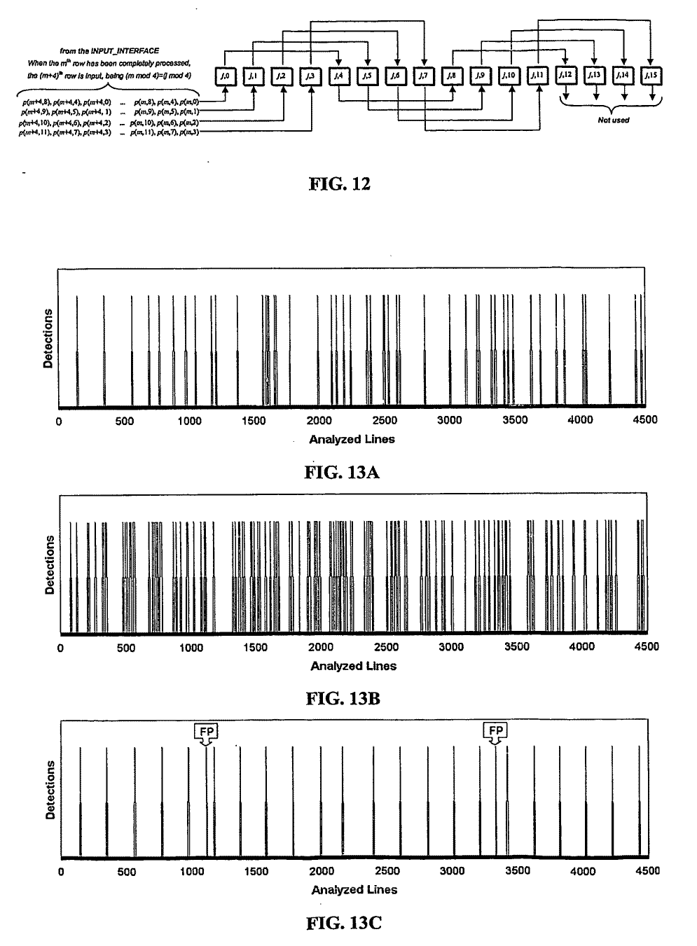

FIG. 12 shows a general line of a shift-register of the system hardware;

FIGS. 13A, 13B and 13C are graphs showing the presence detections of members, with respect to the analyzed lines;

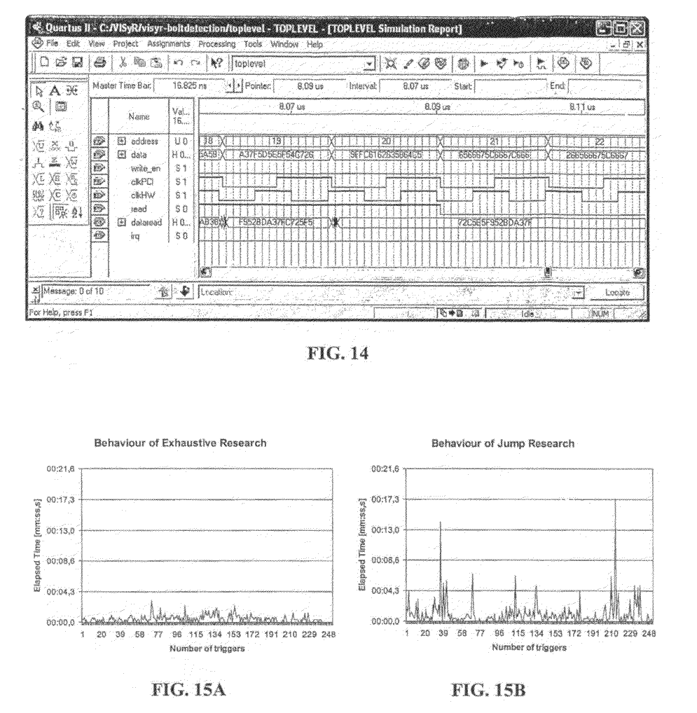

FIG. 14 is a display extracted from the simulation report of the system according to the present invention; and

FIGS. 15A and 15B are graphs showing the switching between two searching 35 modes.

Hereinafter in the description the figures mentioned above will be referred to.

By referring to FIG. 1, it shows a block diagram of an inspection system 1 according to the present invention.

The system 1 comprises an acquisition unit of images 2.

The acquisition unit 2 is based upon a line camera DALSA PIRANHA 2© characterized by 1024 resolution pixels (maximum line rate of 67 kLine/s) and using the Cameralink© protocol. Furthermore, it is provided with a PC-CAMLINK© acquisition card (Imaging Technology CORECO©).

The acquisition unit 2, to the purpose of the here-described exemplifying application, is installed in the in the underneath part of a vehicle on rails, for example a railway car. FIG. 2 shows such installation.

The installation is such that, when the vehicle is moving, the camera can shoot the rails' subsequent images.

In order to reduce the effects of the variable conditions of the natural brightness, the acquisition unit 2 further comprises an apparatus of artificial lighting, preferably equipped with six small lights of OSRAM© 41850 kind. In this way the image acquisition is strong with respect of the changes of natural lighting.

Furthermore, in order to synchronize the data acquisition, the camera is controlled by a “wheel encoder” which sends acquisition pulses at pre-established intervals. Preferably the encoder sends a pulse every 3 mm rolling of the vehicle's wheels, thus determining a resolution along the direction of the rails (main motion direction) equal to 3 mm independently from the vehicle's speed. The pixel resolution along the direction orthogonal to the motion is instead determined to 1 mm.

The acquired images are transmitted in real time to a processing unit 3 which provides for inspecting the image sequence in order to detect the presence/absence of characteristic members of the infrastructure. In particular, hereinafter the processing modes implemented for detecting the presence (or absence) of the hexagonal-head bolts, fastening the rails to the sleepers, will be described.

Therefore, the processing unit 3 provides as result a detailed report about the status of the examined rails and in case showing the indications necessary to detect spacially the tracts wherein a problem has been identified such as, for example, the absence of a bolt.

This report could be then advantageously exploited to provide for the maintenance of the tracts by accessing in direct manner to the tracts having defects, without the need of any additional inspection.

The subsequent FIG. 3 illustrates, through a functional block diagram, the processing modes implemented by the unit 3 in order to obtain the desired result.

In particular, the sequence of acquired images is supplied as input to a first processing sub-unit 4 which functionally provides, among other things, for the extraction of the geometrical coordinates of the rail under examination (RD&TB block).

Considering the high computational complexity, in order to obtain the wished performances, the RD&TB block is advantageously implemented in hardware on a FPGA, thereof more details will be given hereinafter.

The RD&TB block serves to determine the track position in the acquired image. The implemented technique is an accommodation of the method known under the name of EigenFaces. The method is an extension of the Principal Component Analysis (PCA) and it is composed of two phases: a “data reduction” phase wherein the grey levels are mapped in a suitable space (Component Space) so as to reduce the data to be handled, and a “supervisioned classification” phase, based upon a neural network, to detect the track.

Be I(x,y) a track image with M rows and N columns. The image I is part of an input image. Be rᵢ (i=1 . . . P, P≧N) a set of P vectors composed by Q<N pixels extracted from the rows of the image I and selected among the data acquired so as to construct the matrix:

A=[h1, . . . , hP] (E1)

wherein:

hi=ri−μi (E2)

being:

μi=[μi, . . . , μi]T (E3)

Wherein the symbol μᵢ denotes the intensity average in rᵢ.

The vectors rᵢ are chosen so as to select track examples, acquired under different lighting conditions.

The matrix A has a size of N rows and P columns. From A, the covariance matrix can be constructed:

C=AAT (E4)

The matrix N×N, C contains information about the mutual relationships between the track images rᵢ.

According the PCA analysis, the eigenvectors uⱼ (j=1 . . . N) of C define a new reference space wherein the variance between the data is maximized. The eigenvalues λⱼ of C are the variances of data for each one of the uⱼ.

Therefore, the eigenvectors uⱼ ordinated so as:

λk>λk+1(k=1, . . . , N−1) (E5)

mean that the set of input data projections onto uₖ has a greater variance than those related to uₖ₊₁. Therefore, the eigenvalues λⱼ induce an order relationship onto the components uⱼ.

By setting thresholds to the eigenvalues λⱼ it is possible to select the corresponding eigenvectors L (L<N) sufficient to represent 90% of the information content of the input data. Be λₗ (l=1 . . . L, L<N) the selected components, a general vector r′ can be expressed as:

$${r}^{′} \approx {\sum }_{l = 1}^{L} {a}_{l} {u}_{l} + {μ}^{′} \qquad ( E6 )$$

wherein μ′ is the average of r′. From a computational point of view the eigenvectors and the eigenvalues of C can be estimated by the Single Value Decomposition (SVD) of the matrix A wherein the coefficients aᵢ are evaluated by the scalar product:

al=(r′−μ′)ulT (E7)

In this scenario, the vector

a′=[a1, . . . , aL]T (E8)

can be considered a feature containing great part of information of r′.

The track detection phase is based upon training a multilayer perceptron (MLP) on a training set containing examples rᵢ of tracks and not tracks.

The test phase consists in scanning each input image line with a window with size Q (the track size). For each window position, the searching process extracts the vector r′ and it evaluates by means of MLP if r′ is or is not centered onto the track.

The acquisition setup is constituted, as it has been said, by a camera which digitalizes lines of 1024 pixels. In order to detect the track centre, the edge pixels are eliminated and lines of only 800 pixels (N=800) are considered. As the rail width is 301 pixels, the vector rᵢ with 401 pixels (50 edge pixels+301 track pixels+50 edge pixels; Q=401) has been constructed.

The matrixes A and C are derived according to (E1) and (E4), by using 450 examples of vectors rᵢ (P=450). Therefore, the eigenvectors uⱼ and the eigenvalues λⱼ are determined and it is experimentally checked that 12 eigenvectors are sufficient to represent 91% of the information content of the input data (L=12).

The detection system exploits a MLPNC constituted by three layers of neurons (input, hidden and output layer).

The input layer is formed by 12 neurons n_{1,m} (m=0 . . . 11) corresponding to the coefficients aₘ₊₁ calculated by the (E7) onto the vector r′ which must be classified.

The hidden layer consists of 8 neurons n_{2,k} (k=0 . . . 7); they derive from the propagation of the first layer according to:

$${n}_{2 , k} = f ( {bias}_{1 , k} + {\sum }_{m = 0}^{11} {w}_{1 , m , k} {n}_{1 , m} ) \qquad ( E9 )$$

whereas the single neuron n_{3,0} of the output layer is given by:

$${n}_{3 , 0} = f ( {bias}_{2 , 0} + {\sum }_{k = 0}^{7} {w}_{2 , k , 0} {n}_{2 , k} ) \qquad ( E10 )$$

wherein w_{1,m,k} and w_{2,k,0} are the weights between first/second and second/third layers. The activation function f(x), which has codomain ]0, 1[, for both layers is:

$$f ( x ) = \frac{1}{1 + {e}^{- x}} \qquad ( E11 )$$

In this scenario, the output of the classifier n_{3,0} which is in the range ]0,1[ gives a confidence measure about how much the vector r′ is centred onto the track.

The biases and the weights are calculated by using the Error Back Propagation technique with adaptive learning rate and a training set with more than 800 samples.

The processing unit 3 further comprises a prediction sub-unit 5, identified in FIG. 3 with the acronym PAB. The same sequence of acquired images is provided as input to the sub-unit 5 PAB, together with the data related to the rail geometrical coordinates.

The sub-unit 5 PAB utilizes the data received as input to extract from the acquired images the sub-images candidate to contain the hexagonal-head bolts and only these windows will be the inspection subject ones.

In the described case, sub-image windows of 24×100 pixel have been provided. Some examples of such windows are shown in FIG. 4.

These windows are then provided as input to a detection sub-unit 6, also designated with the acronym BDB (Bolt Detection Block) and which will be described in detail.

By referring to FIG. 5, due to the rail structure, the distance Dx between rail and coupling locks is constant and known in advance. In this way, the automatic detection of the rail and the tracking of the same results to be fundamental in determining the position of the bolts along the moving direction x. The detection procedure is carried out by the RD&TB block.

The sub-unit 5 PAB provides the position of the bolts along the direction orthogonal to the motion y. To achieve this purpose a searching phase inside the sub-images is provided. For such searching phase two searching modes are advantageously utilized: an exhaustive search and a jump-like search.

In the first (exhaustive) search kind the searching areas at the (well-known) distance Dx from the rail position are examined, until the first occurrence of the left and right bolts are found at the same time (at the same y). At this point, this position (position A) is determined and stored and the analysis continues in this way until the second occurrence of both bolts (position B) is identified. Therefore, the distance along the direction y between B and A is calculated, designated in FIG. 5 with Dy. At this point, the searching process passes to the jump-like searching mode. In fact, as it is known, the distance along the direction y between two adjacent sleepers is fixed. Furthermore, the jump-like search utilizes Dy to jump only into the areas candidate to contain the windows involved by the hexagonal-head bolts, by saving computation time and accelerating the performances inside the whole system.

If, during the jump-like search, the sub-unit 5 does not find the bolts in the position wherein it is expected, it stores the error position (the one which has generated the alarm) in a log-file and it starts again with the exhaustive search. A pseudo-code describing the switching from the exhaustive search to the jump-like search is shown hereinafter by way of example:

Do Start image sequence to End image sequence;
Repeat
   Exhaustive search;
   If the first left and right bolt is found
      it stores this position (A);
until the second left and right bolt is found;
it stores this position (B);
determines the distance along y between B and A;
Repeat
   jump-like search;
Until the bolts are found where expected;

end do

As already shown, the output of the sub-unit 5 PAB is then provided as input to a sub-unit 6 for detecting the bolts (BDB).

In order to avoid detecting false positives, the sub-unit BDB combines the result of two different processings. It comprises a pre-processing module 7 of the sub-images by means at least a transform function. In particular, such pre-processing module 7 comprises means 7′, 7″ for the simultaneously application of two transforms to the input data, in particular two discreet Wavelet transforms 2-D (DWT), which reduce significantly the input space size. The data outgoing from the pre-processing module, and specifically the results of the two transforms, are provided as input to a classification module 8. The classification module comprises means 8′, 8″ to carry out two different classifications, in particular two respective classifiers based upon neural networks (Multi Layer Perceptron Neural Classifiers, MLPNC).

From tests carried out by means a prototype, BDB provides an accuracy of 99.6% in detecting the existing bolts and of 95% in detecting the absent bolts, furthermore, utilizing the strategy of the results' intersection, it reveals only 1 false positive every 2,250 processed lines of video sequence.

Given the high computational complexity, the whole detection sub-unit 6 is preferably implemented in hardware based upon FPGA (able to carry out BDB processings in 8.09 μs), in cooperation with a prediction algorithm (which, by using the geometry of the railway infrastructures, extracts from the long video sequence a few windows to be analyzed) allows “real time” performances. For example, a long sequence of images covering 9 Km has been inspected at an average rate of 152 km/h, with peaks of 201 km/h.

The process, therewith the system according to the present invention classifies the bolts, is based upon classifiers based upon MLPNC neural networks. The MLPNC computational performances are strictly linked to the prediction algorithm for identifying the search windows candidate to contain the image to be inspected and to the size of the inputs' space (that is, the number of coefficients describing the image).

The system, by means of the prediction sub-unit 5, calculates the distance between the subsequent hexagonal bolts and, based upon this information, predicts the position of the windows wherein the bolt presence is expected.

In order to reduce the size of the inputs' space, the system utilizes a feature of the extraction algorithm which allows preserving all important information about the input images in a small set of coefficients. This algorithm is based upon a Wavelet discreet transform 2-D DWT, considering that DWT concentrates the significant variations of the input images in a reduced set of coefficients.

In the specific case, both a compact wavelet introduced by Daubechies and a Haar DWT (also known as Haar transform) are preferably used in parallel.

By operating this pre-processing process the input windows are reduced to two sets of 150 coefficients (that is, D_LL₂ and H_LL₂), resulting of the Daubechies DWT (DDWT) and of the Haar DWT (HDWT), respectively.

The two sets D_LL₂ e H_LL₂ are then provided to the classification blocks Daubechies Classifier (DC) and Haar Classifier (HC), the outputs thereof are combined with a logic operation of AND to provide the output of the classification module 8 (MLPN).

This detects the presence/absence of bolts and provides a corresponding signal of Pass/Alarm which is displayed in real time (see FIG. 5). In case of alarm (that is absence of bolts), the spacial coordinates and other essential data are stored in a report file.

The function of logical AND avoids almost completely the detection of false positives.

In order to better understand the implemented processing modes, hereinafter some information related to the mathematics of the wavelet transforms and also of the neural classifiers are reported.

The wavelet transform is notoriously a mathematic technique which decomposes a signal in the time domain by using expanded/contracted versions, translated by a single base function of finite duration, called wavelet prototype. This differs from the traditional transforms (for example, Fourier Transform, Cosine Transform, etc.), which utilize base functions of infinite duration. The continuous mono-dimensional (1-D) wavelet transforms of a signal x(t) is:

$$W ( a , b ) = \frac{1}{\sqrt{a}} \int x ( t ) \overline{ψ} ( \frac{t - b}{a} ) d t \qquad ( E12 )$$

wherein

$$\overline{ψ} ( \frac{t - b}{a} )$$

is the conjugated complex of the wavelet prototype,

$$ψ ( \frac{t - b}{a} ) ;$$

a represents an expansion in time and b a translation in time.

Due to the discreet nature (both in time and in space) of several applications, different Wavelet transforms (DWT) have been proposed based upon the signal nature, upon the time and spacial parameters.

The bi-dimensional (2-D) transforms DWT operate through a multi-level decomposition process. A general 2-D DWT decomposition level j is shown in FIG. 7. It can be seen as an additional decomposition of a set 2-D of data LLⱼ₋₁ (LL₀ is the input original image) in four sub-bands LLⱼ, LHⱼ, HLⱼ and HHⱼ. The capital letters and the position thereof relate to the application of monodimensional filters (L for low-pass filter, H for high-pass filter) and to the application direction (first letter for the horizontal direction, second letter for the vertical). The band LLⱼ is a rough approximation of LLⱼ₋₁. The bands LHⱼ and HLⱼ, respectively, store the changes along the horizontal and vertical directions of LLⱼ₋₁, whereas HHⱼ shows the high-frequency components. As for each level along both directions it is necessary to decimate, each sub-band at level j is composed by Nⱼ×Mⱼ elements, wherein Nⱼ=N₀/2^{j} and Mⱼ=M₀/2^{j}. Different properties of the DWT can be emphasized by the use of different filters L and H. Thanks to this flexibility, the DWT was successfully applied to a wide range of applications: discrimination and segmentation of tissues, fractal analysis, image compression, recognition of radar objects, numeric analyses, edge extrapolation, biomedicine, etc.

Furthermore, it was observed that a compact wavelet orthonormal basis introduced by Daubechies is an excellent device to characterize the hexagonal-head bolts with a small number of features containing most part of useful information.

Following the setup of the acquisition process of the system according to the present invention, the sub-unit 5 provides 24×100-pixel sub-images so that they are examined. Different DWT were tested by varying the number of decomposition levels with the purpose of reducing this number without loosing accuracy. The best compromise was reached by the sub-band LL₂ consisting in only 6×25 coefficients. By using the classifier described in the following Section, it guarantees an accuracy of 99.9% in recognizing the bolts from the input images.

At the same time, the block calculates also the DWT sub-band LL₂ of Haar, since the intersection of the results of the two classifiers practically avoids completely the detection of false positives.

The neural networks are utilized in several applications as “rule generation”, approximation of functions, routing, adaptive control, resource allocation, prediction and distribution of the workload, “collision avoidance”, “preference assessment”, etc.

Furthermore, their popularity is due to the image processing applications, especially in extracting information from the images. In fact, the classifiers based upon neural networks have an undeniable advantage with respect to the techniques based upon geometric approaches since they do not require geometric models for representing the objects.

According to the present invention two MLPNC classifiers 8′ and 8″ (DC and HC in FIG. 3) are used, respectively trained for the DDWT (Daubechies) and the HDWT (Haar). The two classifiers DC and HC have the same topology (they differ only in the weight value) and are constituted by three levels of neuron (input, hidden and output level).

The DC [and HC] input level is composed by 150 neurons D_n′ₘ └H_n′ₘ┘(m=0 . . . 149) corresponding to coefficients D_LL₂(i, j) [H_LL₂(i, j)] of the sub-band D_LL₂ [H_LL₂] according to:

D_{—}n′ₘ=D_{—}LL₂(m/25, m mod 25) (E13)

H_{—}n′ₘ=H_{—}LL₂(m/25, m mod 25) (E13′)

The DC [and HC] hidden level consists in 10 neurons D_n″ₖ └H_{—}n′ₖ┘ (k=0 . . . 9); they derive from the propagation of the first level according to:

$$\begin{matrix}{D\_n}_{k}^{″} = f ( {D\_bias}_{k}^{′} + {\sum }_{m = 0}^{149} {D\_w}_{m , k}^{′} {D\_n}_{m}^{′} ) & ( E14 ) \\ {H\_n}_{k}^{″} = f ( {H\_bias}_{k}^{′} + {\sum }_{m = 0}^{149} {H\_w}_{m , k}^{′} {H\_n}_{m}^{′} ) & ( E14 ' )\end{matrix}$$

at last, the unique neuron D_n′″₀ └H_n′″₀┘ of the output level is given by:

$$\begin{matrix}{D\_n}_{0}^{″} = f ( {D\_bias}^{″} + {\sum }_{k = 0}^{9} {D\_w}_{k , 0}^{″} {D\_n}_{k}^{″} ) & ( E15 ) \\ {H\_n}_{0}^{″} = f ( {H\_bias}^{″} + {\sum }_{k = 0}^{9} {H\_w}_{k , 0}^{″} {H\_n}_{k}^{″} ) & ( E 15 ' )\end{matrix}$$

wherein D_w′_{m,k} and D_w″_{k,0} [H_w′_{m,k} e H_w″_{k,0}] are the weights between the first/second and the second/third level, respectively.

The activation function ƒ(x), with a range ]0, 1[, for both levels, is:

$$f ( x ) = \frac{1}{1 + {e}^{- x}} \qquad ( E16 )$$

In this scenario, D_n′″₀ └H_n′″₀ assumes values between 0 and 1 and it provides a measure of the reliability with respect to the presence of the object to be detected in the current search window, according to the DC [HC].

D_n′″₀ and H_n′″₀ combine as follows:

Presence=(D_{—}n′″₀>0.9) AND (H_{—}n′″₀>0.9) (E17)

so as to provide the final result of the Classifiers.

The biases and the weights are calculated by using the Error Back Propagation algorithm with an adaptative learning rate and a training set of more than 1,000 examples.

As already indicated previously, some units and/or sub-units are implemented in hardware. Nowadays, the programmable logics play a strategic role in several fields. In fact, during the last twenty years, flexibility requirements have been strongly required so as to reduce more and more the time-to-market times. Furthermore, generally the FPGAs are the first devices which implement the state of art of the silicon technology.

Therefore, even if initially the FPGAs have been created to develop simple logic, currently they represent the systems' heart in different field, such as precision measurement systems, multimedia, image processings, signal processing, medical instrumentation, cryptology/cryptoanalysis, power systems, video compression, communication systems, control systems, image recognition, database for recognizing finger-prints in real-time, etc.

In order to allow the system according to the present invention to obtain real time performances, the blocks with greater computational load have been implemented in hardware: in particular the sub-unit 6 BDB, in the pre-processing module DWTPB and classification module MLPNCB.

As prototype development platform a kit of Altera, PCI High-Speed Development Kit Stratix™ Professional Edition (FIG. 9) has been adopted, which among other features has: a device Stratix™ EP1S60F1020C6 FPGA, 256-MByte PC333 DDR SDRAM, 32-bit or 64-bit PCI and 8/16-bit, differential I/O up to 800 Mbps.

The device Stratix™ EP1S60F1020C6 FPGA is equipped with 57,120 Look Up Table (LUT), 18 DSP block and several memory elements of different sizes which globally reach 5,215,104 bits with a whole band of more than 10 Tbits/s.

The environment for the design, simulation and test is the QuartusII™. FIG. 10 shows a display of Quartus II™ CAD tool with a highest schematic view.

The architecture can be interpreted as memory:
the operation starts when the host “writes” a 24×100-pixel window to be analyzed. In this phase, the host recalls the double-gate memories inside the INPUT_INTERFACE (pin address[9 . . . 0]) and sends the 2400 byte to the data input pins[63 . . . 0] under the form of 300 64-bit words.
As soon as the machine has completed its work, the output line irq signalls that the results are ready. At this point, the host “reads” them by recalling the FIFO memory inside the OUTPUT_INTERFACE.

The INPUT_INTERFACE block receives the input data and separates the input phase from the processing phase, this mainly to make the processing phase synchronous and independent from the delays which could be onto the bus PCI during the input. Furthermore, it allows operating at a higher frequency (clkHW signal) with respect to the I/O (clkPCI signal).

The Daubechies 2-D DWT pre-processing is carried out by means of the cooperation of the SHIFTREGISTERS block with the DAUB_LL2_FILTER one.

In order to safeguard the resources and the calculation time, the processing in floating point has been discarded and the calculation in fixed point precision has been adopted. Furthermore, as exclusively the sub-band LL₂ is of interest, the attention has been focused on the latter.

It can be noted that the 2-D DWT filter proposed by Daubechies has the 1-D L filter:

| | | | | | | |
|---|---|---|---|---|---|---|
| 0.035226 | −0.08544 | −0.13501 | 0.45988 | 0.80689 | 0.33267 | (E18) |

And that the sub-band LL₂ can be calculated in one single bidimensional step (instead of in the classic mode which provides two monodimensional steps shown in FIG. 7), followed by a decimation of 4 both along the rows and the columns. FIG. 11 shows the symmetrical kernel 16×16 which has been applied.

The splittable method is greatly efficient in computing all four sub-bands for each level. But the classification process of the system according to the present invention does not need additional sub-bands apart from LL₂.

Furthermore, when the fixed precision is used, each step of the splittable method provides the results with a different dynamics, in this way the hardware used at a determined step results to be unusable to carry out additional steps.

The error (due to the fixed point precision) generated in a single step does not propagate and it can be easily controlled. On the contrary, when the splittable approach is used for calculating the sub-band LL₂, the error propagates along the four steps.

In this optics, the SHIFTREGISTERS implements a 16×16 matrix which scrolls, onto the 24×100 input window, by moving by 4 along the columns at each clock cycle. This is implemented by a route as indicated in FIG. 12, wherein the row j^{th} (j=0 . . . 15) of the 16×16 matrix is represented. The shifting by 4 along the rows is implemented by the INPUT_INTERFACE which inserts in the j^{th} row of the matrix only the pixels p(m, n) of the 24×100 (m=0 . . . 23, n=0 . . . 99) input window, wherein (j mod 4)=(m mod 4).

Every clock stroke sixteen contiguous' rows of the input window in parallel in the SHIFTREGISTERS are sent at a rate of 64 bytes/cc (4 bytes for each line for 16 lines) through IN[511 . . . 0]. Simultaneously, all 256 bytes stored in the 16×16 memory are sent in parallel in the DAUB_LL2_FILTER through OUT_{—}256bytes[2047 . . . 0].

DAUB_LL2_FILTER exploits the kernel symmetry (see FIG. 11), by adding the pixels coming from the cells (j, i) to those from the cells (i, j) (j=0 . . . 15, i=0 . . . 15); subsequently, it calculates the products of there sums and of the diagonal elements of the matrix with the related filter coefficients and, to end up, it accumulates these products.

Consequently, DAUB_LL2_FILTER produces the coefficients LL₂, after a latency of 11 ccs, at a rate of 1 coefficient/cc. These are now expressed in 35 bit, due to the increase in dynamics, and they are input into 1LEV_MLPN_CLASSIFIER through D_LL2[34 . . . 0].

The Haar transform is a very simple DWT, in fact the related 1-D filters are: L=[½, ½] and H=[½, −½]. Consequently, any coefficient H_LL₂(i, j) can be calculated in one single step:

$${H\_LL}_{2} ( i , j ) = \frac{1}{16} {\sum }_{l = 0}^{l = 3} {\sum }_{k = 0}^{k = 3} p ( 4 i + k , 4 j + l ) \qquad ( E20 )$$

In order to calculate such coefficient, the same SHIFTREGISTERS block is utilized, used for Daubechies DWT, and a HAAR_LL₂_{_{—}}FILTER block. The HAAR_LL₂_{_{—}}FILTER block sums the data which coming from OUT_TO_HAAR_{—}16 bytes[255 . . . 0] which represent the values of the pixels p(m, n) of the 4×4 window centred onto the scrolling 16×16 matrix, implemented by the SHIFTREGISTERS.

In this way, after a latency of 2 clock cycles, HAAR_LL2_FILTER produces a coefficient (expressed by 12 bits) per block cycle and it sends it to the 1LEV_MLPN_CLASSIFIER block through H_LL2[11 . . . 0].

As it has been described previously, the calculation which the MLPN classifier must perform are (for both the DC and HC classifiers):

$$\begin{matrix}{D\_n}_{k}^{″} = f ( {D\_bias}_{k}^{′} + {\sum }_{m = 0}^{149} {D\_w}_{m , k}^{′} {D\_n}_{m}^{′} ) & ( E21 ) \\ {H\_n}_{k}^{″} = f ( {H\_bias}_{k}^{′} + {\sum }_{m = 0}^{149} {H\_w}_{m , k}^{′} {H\_n}_{m}^{′} ) & ( E 21 ' )\end{matrix}$$

followed by:

$$\begin{matrix}{D\_n}_{0}^{′″} = f ( {D\_bias}^{″} + {\sum }_{k = 0}^{9} {D\_w}_{k , 0}^{″} {D\_n}_{k}^{″} ) & ( E22 ) \\ {H\_n}_{0}^{′″} = f ( {H\_bias}^{″} + {\sum }_{k = 0}^{9} {H\_w}_{k , 0}^{″} {H\_n}_{k}^{″} ) & ( E 22 ' )\end{matrix}$$

Due to the hardware high costs, necessary for implementing the activation function f(x)—see eq. (E16)—, it is preferable implementing in 1LEV_MLPN_CLASSIFIER the equations:

$${D\_x}_{k} = {D\_bias}_{k}^{′} + {\sum }_{m = 0}^{149} {D\_w}_{m , k}^{′} {D\_n}_{m}^{′} \qquad ( E23 )$$

$${H\_x}_{k} = {H\_bias}_{k}^{′} + {\sum }_{m = 0}^{149} {H\_w}_{m , k}^{′} {H\_n}_{m}^{′} \qquad ( E23 ' )$$

for k=0 . . . 9.

The equations (E23) and (E23′) represent the arguments of the activation function of (E21) and (E21′). By doing this, such arguments are calculated in hardware and are sent to the host, which in software calculates ƒ(D_xₖ), ƒ(H_xₖ), (E22), and (E22′). However, (E23) and (E23′) represent 3,000 multiplications and 3,000 sums which are calculated in hardware, against 20 multiplications, 20 sums, 22 activation functions and the comparison to the threshold (E17), calculated in the software by the host.

In order to perform this operation, 1LEV_MLPN_CLASSIFIER has been equipped with two sets of 10 Multiplier-and-ACcumulators (MACs), that is, D_MACₖ and H_MACₖ (k=0 . . . 9).

As soon as a coefficient D_LL₂(i, j) [H_LL₂(i, j)] is produced by DAUB_LL2_FILTER [HAAR_LL2_FILTER], the multipliers D_MACₖ [H_MACₖ] multiply it in parallel times D_w′_{m,k} [H_w′_{m,k}] (m=25i+j, k=0 . . . 9) and continue in this way for 150 clock strokes, a clock stroke (cc) for each one of the 150 coefficients of D_LL₂ [H_LL₂].

The weights D_w′_{m,k} and H_w′_{m,k} have been previously stored in 20 LUTs during the setup (a LUT for each multiplier, which stores the 150 weights). The accumulator of each D_MACₖ [H_MACₖ] is initialized with D_biask [H_biask] and it accumulates the products as soon as they are calculated by the multipliers.

Due to the latency, the operation of the 1LEV_MLPN_CLASSIFIER block ends up after 5 ccs from the last coefficients, D_LL₂(5, 24) and H_LL₂(5, 24), provided by DAUB_LL2_FILTER and by HAAR_LL2_FILTER. At this point, the data stored in the 20 accumulators of D_MACₖ and of H_MACₖ (k=0 . . . 9) have now 63 bits and 45 bits, respectively, due to the increase in the dynamics. They are sent to the OUTPUT_INTERFACE block by means of DC_OUT_{—}63 bits_X_{—}10 neurons[629 . . . 0] and HC_OUT_{—}45 bits_X_{—}10 neurons[449 . . . 0].

These data are extended in sign and formatted in 64-bit words by the OUTPUT_INTERFACE block. Furthermore, OUTPUT_INTERFACE serializes them by using a FIFO and it generates the irq signal which indicates that the results are ready to be collected. To end up, the host requires these results (read signal) and receives them on the dataread[63 . . . 0] (1 word/cc).

The following Table 1 sums-up the resource engagement required by the architecture. The Table shows also a comparison between the resources available on the Stratix™ EP1S60F1020C6 FPGA. In the partial use of the resources it is to be considered that also the previously described RD&TB block must be implemented on the same FPGA.

TABLE 1
USED RESOURCES

| | Used | Available | |
|---|---|---|---|
| | resources | resources | Use |
| Total logical elements | 31,577 | 57,120 | 55% |
| Total pins | 149 | 1,020 | 15% |
| Total memory bits | 71,738 | 5,215,104 | 1% |
| DSP blocks | 10 | 18 | 55% |

### DESCRIPTION OF THE EXPERIMENTAL RESULTS AND OF THE PERFORMANCES

In order to design and verify the processing core of the system according to the present invention, a sequence of rail images for about 9 Km has been acquired.

First of all, a known Error Back Propagation procedure with “adaptive learning rate” has been used to determine the biases and the classifier's weights. The image set adopted for training the neural network of the classifier includes 391 positive examples of hexagonal bolts with different orientation, and 703 negative examples represented by 24×100-pixel windows exctracted from the acquired video sequence.

The remaining video sequence has been used to perform the following tests.

In defining the pre-processing strategy it has been observed that, although the DC classifier, based upon the DWT of Daubechies, has reached a very high detection rate (see part VII.C), nevertheless it has produced a certain number of false positives (FP) during the search in exhaustive phase.

In order to reduce these errors, a cross validation phase has been introduced. Then, the Haar DWT has been tested, given its scarse computational weight. The HC classifier is a neural classifier which operates with the sub-band LL₂ produced by the Haar DWT, and it has been designed and trained. HC reaches the same detection rate of DC, even if it detects several more false positives.

However, the false positives detected by HC derive from different features (windows) with respect to the false positives produced by DC. This phenomenon is underlined in FIG. 13C, wherein the result of the AND function applied between the detections (both real and false positives) obtained by DC (FIG. 13A) and by HC (FIG. 13B) is shown, when they have processed, in exhaustive phase (that is, without jump between the bolt pairs) 4,500 lines of the acquired video sequence.

As it results clear, only two false positives have been detected, with respect to analyzed 4,500 lines (analyzed 90,000 features), by means of the cross validation obtained through the AND function of DC and HC. The numerical results are shown in the following Table 2.

It can be noted that the FP/TP relationship is linked to the exhaustive phase, but it is reduced drastically during the jump-like search, which involves more than 98% of the processed lines (see section VII.E).

TABLE 2
FALSE POSITIVES (EXHAUSTIVE SEARCH)

| | Real | False | | |
|---|---|---|---|---|
| | positives | Positives | | FP/Analyzed |
| | (TP) | (FP) | FP/TP | lines |
| Haar DWT | 22 (100%) | 90 | 409% | 200.0 0/000 |
| Daubechies DWT | 22 (100%) | 26 | 118% | 57.8 0/000 |
| AND (Daubechies, | 22 (100%) | 2 | 9% | 4.4 0/000 |
| Haar) | | | | |

In order to measure the accuracy of the system in detecting the presence/absence of the bolts, a prototype of the wholly software system has been carried out, which adopts precision of “floating point” type, in “trace” mode which allows to an observer to control the correctness of the automatic detections.

This experiment has been carried out for a sequence of 3,350 bolts. The system has detected 99.9% of visible bolts, 0.1% of hidden bolts and 95% of absent ones, as shown in the following Table 3.

TABLE 3
ACCURACY

| | |
|---|---|
| Floating Point | Fixed Point |

| Number of examined bolts | 3,350 | | 3,350 | |
|---|---|---|---|---|
| Number of visible bolts | 2,649 | | 2,649 | |
| Detected | 2,646 | (99.9%) | 2,638 | (99.6%) |
| Number of hidden bolts | 721 | | 721 | |
| Detected | 1 | (0.1%) | 1 | (0.1%) |
| Number of absent bolts | 21 | | 21 | |
| Detected | 20 | (95%) | 20 | (95%) |

The report (file log) obtained by the above-mentioned test has been used as comparison term for the reports of similar experiments, which aim at defining the number of bits of the words to be used in the hardware design.

The software prototype has been modified by floating point in fixed point. The different versions of the software procedures have been compiled with different precisions (that is number of used bits) both for the coefficients of the Daubechies filter and for the weights both of DC and HC. The setting with 23 bits for the filter coefficients and with 25 bits for the weights of both classifiers has produced a lo lower accuracy, in detecting the visible bolts, of only 0.3% than the one obtained using the precision in floating point. This compromise has been considered acceptable and the hardware has been developed by using these specifications.

Subsequent experimental tests have allowed to test the whole system (hardware and software) with the whole video sequence, to measure the reached calculation performances. The results of this test are shown in the following Table 4.

TABLE 4
OBTAINED PERFORMANCES

| Processed lines | 3,032,432 | [lines] | 9.097 | [km] |
|---|---|---|---|---|
| Total time | 215.34 | [sec] | | |
| Speed | 14,082 | [lines/sec] | 152.1 | [km/h] |
| Jumped lines | 2,980,012 | [lines] | 98.2% | |
| computational time of | 159.93 | [sec] | 74.3% | |
| the jump-like search | | | | |
| computational speed of | 18,633 | [lines/sec] | 201.2 | [km/h] |
| the jump-like search | | | | |
| lines processed in | 52,420 | [lines] | 1.8% | |
| exhaustive way | | | | |
| computational time of | 55.41 | [sec] | 25.7% | |
| the exhaustive search | | | | |
| computational speed of | 946 | [lines/sec] | 10.2 | [km/h] |
| the exhaustive search | 15,027 | | | |
| Pairs of examined bolts | | | | |

These data derive from a software architecture developed in Visual C++, version 6.00 performed on a 3.2-GHz Pentium IV™ with 1 GB of the RAM which cooperates with the hardware architecture described in part VI, clocked at 66 MHz and 100 MHz, which performs the analysis of a 24×100 window in 8.09 μs (see FIG. 14).

The present invention has been so far described according to a preferred embodiment thereof, shown by only way of example and not with limitative purpose.

It is to be meant that other embodiments may be provided, all to be considered belonging to the protection scope of the same, as defined by the enclosed claims.

1. Automatic method for infrastructure visual inspection, for detecting characterizing features of the infrastructure itself, comprising the following steps of:
acquiring images in sequence of subsequent portions of said infrastructure;
extracting from said acquired images geometrical coordinates of said infrastructure;
extracting from said acquired images, based upon said geometrical coordinates, sub-images corresponding to provided positions of said characterizing members; and
detecting in said sub-images the presence/absence of said characterizing members.

2. Method according to claim 1, wherein said step of detecting in said sub-images the presence/absence of said characterizing members comprises:
a phase of pre-processing said sub-images by means of at least a transform function; and
a phase of classifying said sub-images pre-processed by means of at least a classifier, by determining the presence/absence of said characterizing members.

3. Method according to claim 1, wherein said step of extracting the geometrical coordinates from the acquired infrastructure images comprises a phase of data reduction in order to reduce the data to be handled, and a supervisioned classification phase, based upon neural network.

4. Method according to claim 1, wherein said step of extracting sub-images containing said characterizing members, comprises a phase of searching said characterizing members inside each one of said acquired images.

5. Method according to claim 4, wherein said searching phase comprises a searching mode of “exhaustive” type.

6. Method according to claim 4, wherein said searching phase comprises a second searching mode of “jump”-like type.

7. Method according to claim 5, wherein said searching phase is so as to alternate said first and second searching mode, depending upon the obtained results.

8. Method according to claim 2, wherein said step of pre-processing said sub-images by means of at least a transform function provides the simultaneous application of two transforms of “bidimensional wavelet” type to the input data themselves.

9. Method according to claim 8, wherein a first one of said two transforms of “bidimensional wavelet” type is a Daubechies transform.

10. Method according to claim 9, wherein a second one of said two transforms of “bidimensional wavelet” type is a Haar transform.

11. Method according to claim 9, wherein said step of classifying said sub-images pre-processed by means of at least a classifier provides a first phase of classifying the results of said pre-processing by means of the Daubechies transform.

12. Method according to claim 10, wherein said step of classifying said sub-images pre-processed by means of at least a classifier provides a second step of classifying the results of said pre-processing by means of Haar transform.

13. Method according to claim 11, wherein the results of said first and second classification phases are combined by means of a logical function.

14. Method according to claim 13, wherein said logical function is an AND function.

15. Method according to claim 11, wherein said at least one classifier is a classifier of neural type.

16. Method according to claim 1, operating in real time.

17. Automatic automatized system of visual inspection of an infrastructure for detecting the characterizing members of the infrastructure itself, comprising an image acquisition unit (2) and a processing unit (3), wherein said processing unit (3) comprises:
a first sub-unit (4) for extracting geometrical coordinates of said infrastructure from said acquired images;
a second prediction sub-unit (5) for extracting from said acquired images, based upon said geometrical coordinates, sub-images corresponding to provided positions of said characterizing members; and
a third detection sub-unit (6) apt to determine the presence/absence of said characterizing members in said sub-images.

18. System according to claim 17, wherein said third detection sub-unit (6) comprises a module (7) for pre-processing said sub-images by at least a transform function and a module (7) for classifying said sub-images pre-processed by means of at least a classifier.

19. System according to claim 17, wherein said prediction sub-unit (5) comprises means for reducing the data and means for classifying said data, based upon neural network.

20. System according to claim 17, wherein said prediction sub-unit (5) comprises means for searching said characterizing members inside each one of said acquired images.

21. System according to claim 20, wherein said means for searching said characterizing members inside each one of said acquired images is apt to perform a searching mode of “exhaustive” type.

22. System according to claim 20, wherein said means for searching said characterizing members inside each one of said acquired images is apt to perform a searching mode of “jump”-like type.

23. System according to claim 21, wherein said means for searching said characterizing members inside each one of said acquired images is apt to alternate said first and second searching mode, depending upon the obtained results.

24. System according to claim 18, wherein said preprocessing module (7) comprises means (7′, 7″) in order to apply simultaneously two transforms of “bidimensional wavelet” type to the same input data.

25. System according to claim 24, wherein a first one of said two transforms of “bidimensional wavelet” type is a Daubechies transform.

26. System according to claim 24, wherein a second one of said two transforms of “bidimensional wavelet” type is a Haar transform.

27. System according to claim 24, wherein said classification module (8) comprises first means (8′) in order to perform a first classification of the results of said pre-processing by means of the Daubechies transform.

28. System according to claim 24, wherein said classification module (8) comprises second means (8″) in order to perform a second classification of the results of said pre-processing by means of a Haar transform.

29. System according to claim 27, wherein said classification module (8) comprises means for combining the results of said first and second classification by means of a logical function.

30. System according to claim 29, wherein said logical function is an AND function.

31. System according to claim 27, wherein said first and second classification means (8′, 8″) are classifiers of neural type.

32. System according to claim 17, operating in real time.

33. (canceled)
